(19) United States
(12) Patent Application Publication
(10) Pub. No.: US 2003/0096615 A1
(43) Pub. Date: May 22, 2003

(54) Signaling of a call in a telecommunications system between a base station and a mobile component

(76) Inventors: Michael Beckers, Hamminkeln (DE); Hans-Georg Beerens, Bocholt (DE); Rolf Biedermann, Ahaus (DE); Christoph Lenfort, Bocholt (DE); Georg Schmitz, Rhede (DE)

Correspondence Address: BELL, BOYD & LLOYD, LLC, P. O. BOX 1135, CHICAGO, IL, 60690-1135, US

(21) Appl. No.: 10/204,803

(22) PCT Filed: Feb. 6, 2001
(86) PCT No.: PCT/DE01/00447

(30) Foreign Application Priority Data
Feb. 23, 2000 (DE) 100 08 241.6

(51) Int. Cl. H04Q 7/38

(52) U.S. Cl. 455/450; 455/445

(57) ABSTRACT

The invention relates to a base station to which especially more mobile components are allocated than the number of radio channels provided. The base station signals an incoming connection request to the mobile components in such a way that said station establishes a bidirectional connection to one of the mobile components after the connection request has been received, whereby the base station thus signals the incoming connection request and subsequently suppresses said request. This is sequentially repeated by means of at least one component of the mobile components. In addition, the base station can simultaneously establish a unidirectional connection to all mobile components and signal the incoming connection request immediately after the connection request has been received.

The invention relates to a method for call signaling in a telecommunication system between a base station and a portable part.

In communication systems with a message transmission link between a message source and a message link, transmitting and receiving devices are used for processing and transmitting messages, in which

1) the message processing and message transmission can take place in a preferred direction of transmission (simplex mode, unidirectional) or in both directions of transmission (duplex mode, bidirectional),

2) the message processing is analog or digital,

3) the message transmission takes place wirelessly via the remote transmission link on the basis of various message transmission methods FDMA (Frequency Division Multiple Access), TDMA (Time Division Multiple Access) and/or CDMA (Code Division Multiple Access)—e.g. in accordance with radio standards such as DECT, GSM, WACS or PACS, IS-54, PHS, PDC etc. [compare IEEE Communications Magazine, January 1995, pages 50 to 57; D. D. Falconer et al.: “Time Division Multiple Access Methods for Wireless Personal Communications”].

“Message” is a generic term which stands both for the meaning (information) and the physical representation (signal). In spite of the same meaning of a message—that is to say the same information—different signal forms can occur. Thus, e.g., a message relating to an object can be transmitted

(1) in the form of an image,

(2) as spoken word,

(3) as written word,

(4) as encrypted word or image.

The type of transmission according to (1) . . . (3) is in this case normally characterized by continuous (analog) signals whereas discontinuous signals (e.g. pulses, digital signals) are usually produced in the type of transmission according to (4). On the basis of this general definition of a communication system, the invention relates to a cordless telecommunication system with cordless telecommunication applications, particularly a GAP-specific DECT system.

According to the DECT standard, a maximum of 12 connections according to the TDMA/FDMA/TDD (Time Division Multiple Access/Frequency Division Multiple Access/Time Division Duplex) method can be set up in parallel to DECT portable parts at a DECT base station via a DECT air interface designed for the frequency band between 1.88 and 1.90 GHz. The number 12 is obtained from a number k of timeslots or telecommunication channels (k=12) available for the duplex mode of a DECT system. The connections can be internal and/or external in this case. In the case of an internal connection, two portable parts registered at the base station can communicate with one another. To set up an external connection, the base station is connected to a telecommunication network, e.g. via a telecommunication line unit or, respectively, a private branch exchange. In the case of the external connection, it is possible to communicate with a subscriber in the telecommunication network by means of a portable part via the base station, the telecommunication line unit or, respectively, the private branch exchange. If the base station has only one connection to the telecommunication line unit or the private branch exchange, respectively, as in the case of the Gigaset 951 (Siemens cordless telephone, compare telcom report 16, (1993), vol. 1, pages 26 and 27, only one external connection can be set up.

On the basis of the simple DECT system used preferably for the private domain, DECT system applications are then conceivable, e.g. in the public microcell area, in which a number n of portable parts with n>k are connected to a base station via the DECT air interface.

If in such a system the case occurs that the request of a remote telecommunication subscriber from the telecommunication network to set up a telecommunication link with one of the portable parts is signaled to a base station which, i.e., can be constructed as antenna diversity base station, the base station must report this to its associated portable parts. This reporting is done, for example, in that it rings the portable parts (acoustic indication). As an alternative, other forms of indication are also possible (e.g. visual indication).

The report from the base station to the portable stations that a remote telecommunication subscriber from the telecommunication network wishes to communicate with one of the portable parts occurs simultaneously in this case through a unidirectional radio link (dummy bearer, traffic bearer) from the base station to all its associated portable parts.

However, for this type of reporting there is an uncertainty about whether the signaling of an existing call request has been received at all portable parts.

The object forming the basis of the invention is to specify a method for calling a number n of portable parts allocated to a base station.

This object is achieved by the features of claim 1 and by the features of claim 2.

According to claim 1, a call request which was received from a remote telecommunication subscriber of a telecommunication network connected to a base station is signaled to all n of the portable parts allocated to the base station in that the base station successively sets up a temporary bidirectional radio link with at least some of the n portable parts, for example at least n−(k+1) portable parts, beginning with a first portable part of the n portable parts, exchanges data with the first portable part via this bidirectional radio link and subsequently releases the bidirectional radio link, the data containing at least one message which signals the incoming call request and the respective portable part indicating the incoming call request by call signaling.

The essential advantage of the method according to the invention, according to claim 1, is the possibility of checking whether the signaling of the incoming call request has been received at the respective portable part (verified call signaling) so that, depending on the result of the checking, the base station may be able to carry out alternative methods, only one radio channel being needed overall due to the sequential procedure for the signaling.

According to claim 2, a call request received from a remote telecommunication subscriber of a telecommunication network connected to a base station is simultaneously signaled to at least some of the n portable parts allocated to the base station by using for this purpose a unidirectional radio link which continuously exists between base station and all portable parts, particularly in wireless telecommunication systems operating in accordance with the DECT standard, so that [lacuna] indicates all portable parts almost simultaneously by call signaling by transmitting data via the respective unidirectional radio link, which contain at least one message which signals the incoming call request, and following this successively in each case sets up a temporary bidirectional radio link with at least some of the n portable parts, beginning with a first portable part of the n portable parts, exchanges data with the first portable part via this bidirectional radio link and subsequently releases the bidirectional radio link.

The essential advantage of the method according to the invention, according to claim 2, is the possibility of checking whether the signaling of the incoming call request has been received at the respective portable part so that, depending on the result of the checking, the base station can carry out alternative methods, and this checking takes place after the simultaneous signaling of the incoming call and does not delay this signaling.

This is used particularly advantageously in a telecommunication system, in which more portable parts are allocated to a base station than radio channels are available (n>k).

If a portable part accepting the incoming call request sets up a bidirectional radio link for signaling the acceptance, a data exchange can take place via this radio link, particularly the call with the remote subscriber and, in addition, the base station can inform the remaining portable parts about the end of the call request.

The essential advantage of the developments according to claim 6 and 7 is direct signaling of the acceptance of the incoming call request to the remaining portable parts and the development according to claim 5, in addition, also provides for a check whether the signaling of the acceptance has been received at all remaining portable parts.

The essential advantage of the developments according to claim 8 and claim 9 is the refreshing of the signaling of the incoming call request and this refreshing can be checked for arrival at the respective portable part and, according to claim 8, avoids a delay in the signaling in that sequential checking proceeds following the simultaneous signaling.

The advantage of the development according to claim 10 is the verified active ending of the refreshing by the base station.

The essential advantage of the developments according to claim 11 and 12 is the verified active ending of the refreshing, and the development according to claim 12, in addition, provides for a check whether the request for ending has been received at all remaining portable parts.

The essential advantage of the development according to claim 13 is the possibility of ensuring a verified ending of the refreshing of the signaling without having to set up a radio link from the base station to one of the portable parts.

The advantage of the development according to claim 14 and claim 15 is the direct indication of the change of data allocated to the incoming call request, and transmission of this change.

The development according to claim 16 is of advantage for ensuring that messages directed to the base station are also possible during the call.

The development according to claim 17 puts a simple collision treatment which provides for a precise response in dependence on the content of the message if a portable part wishes to transmit a message to the base station, for example according to claim 15, and cannot set up the radio link required for this since all radio channels are occupied.

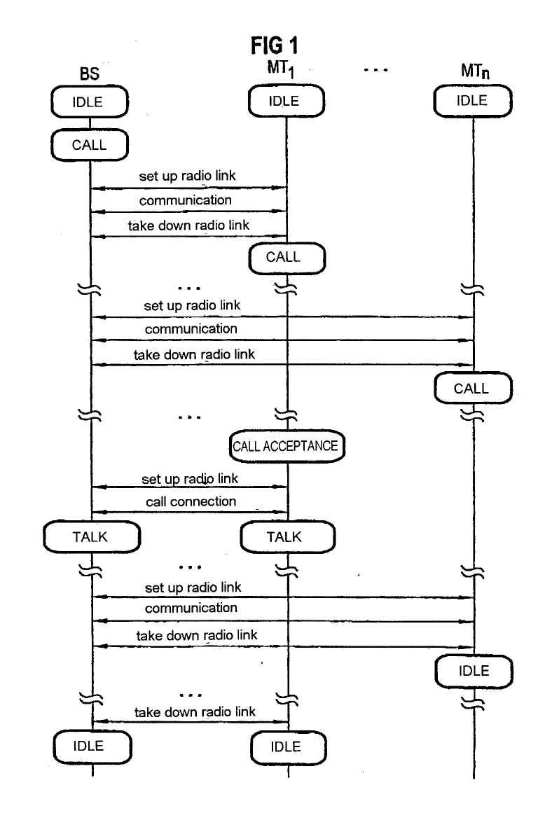

Exemplary embodiments of the invention will be explained with reference to FIGS. 1 to 3, in which:

FIG. 1 shows a sequence chart of a method with signaling, checking of the signaling and ending of the call signaling via bidirectional radio links.

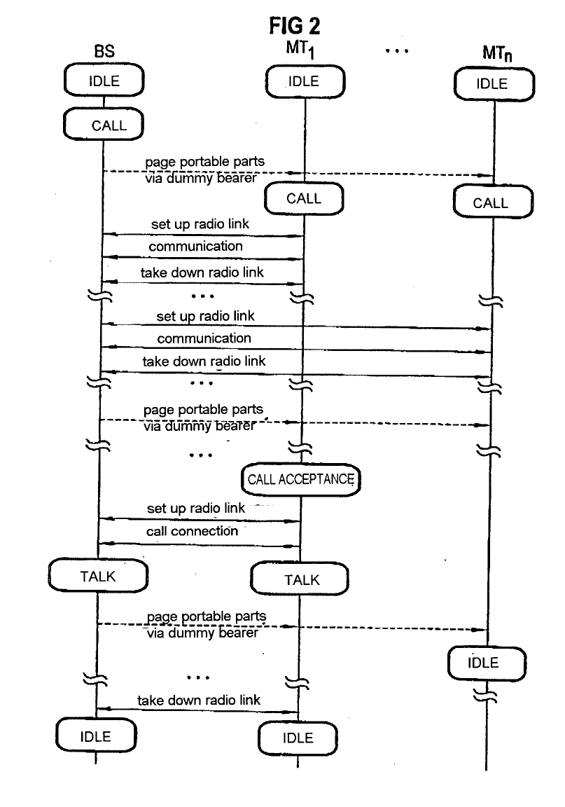

FIG. 2 shows a sequence chart of a method with signaling and ending of the call signaling via unidirectional radio links and checking via bidirectional radio links.

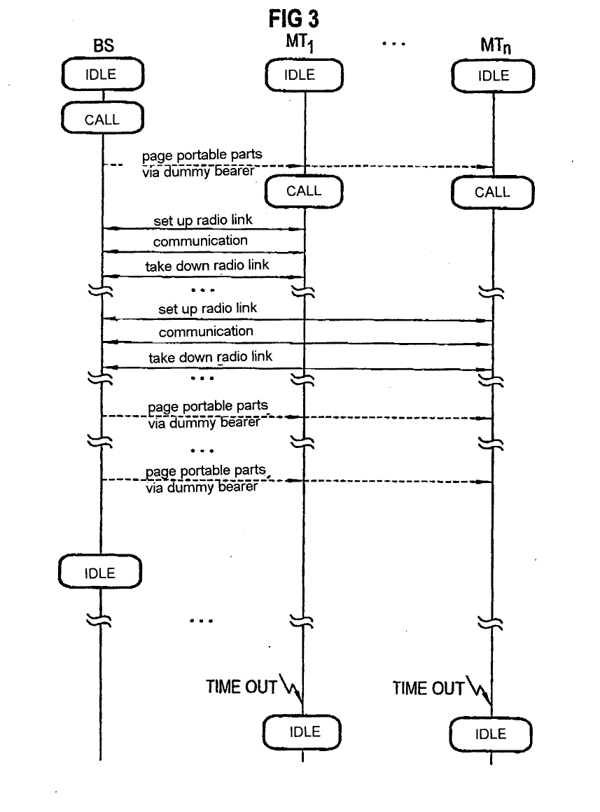

FIG. 3 shows a sequence chart of a method for signaling via unidirectional radio links and checking via bidirectional radio links and ending of the call signaling after timer interrogation.

The sequence chart shown in FIG. 1 specifies the states of a base station BS and its associated portable parts MT₁ . . . MTₙ, the states of the portable parts MT₂ to MTₙ₋₁ not being drawn for the purpose of simplification but corresponding to the sequence of the states of the portable part MTₙ.

In the initial state, all three entities shown are in the IDLE state. Following an incoming call request from an external remote subscriber which is signaled to the base station BS by a telecommunication network TKN, to which the base station is connected, the base station BS changes into the CALL state.

In the CALL state, the base station BS begins to signal the incoming call request to its associated portable parts MT₁ . . . MT_{N}.

For this purpose, the base station BS successively sets up a bidirectional radio link with in each case one of the portable parts MT₁ . . . MTₙ allocated to the base station BS, the radio link being set up in familiar manner. Via this radio link, the respective portable part MT₁ . . . MTₙ exchanges data, call patterns, display messages, voice adjustments etc (communication) with the base station BS, following which the base station then taking down the bidirectional radio link to the respective portable part MT₁ . . . MTₙ and the respective portable part MT₁ . . . MTₙ changing into the CALL state, i.e. an incoming call is signaled to the subscriber (user) of the respective portable part MT₁ . . . MTₙ, for example by ringing, vibrating or visual display.

If then, as shown in FIG. 1, a first portable part MT₁ accepts the call request (subscriber accepts call, for example by operating a key), i.e. the portable part MT₁ changes into the CALL ACCEPTANCE state, the first portable part MT₁ sets up a bidirectional radio link and handles a call to the external subscriber via this radio link which places both the base station BS and the first portable part MT₁ into the TALK state, whereupon the base station BS signals the end of the call request to the remaining portable parts MT₂ . . . MTₙ.

For this purpose, the base station BS again successively sets up in each case a bidirectional radio link to the remaining portable parts MT₂ . . . MTₙ, exchanges data with the respective portable part MT₂ . . . MTₙ via this link, which data contains, among other things, the information that the end of the call request has occurred or, respectively, the first portable part MT₁ has accepted the incoming call request, and then in each case takes down the radio link.

After evaluating the information, the respective portable part MT₂ . . . MTₙ changes into the IDLE state.

After the end of the conversation between the external subscriber and the first portable part MT₁, the existing bidirectional radio link between the first portable part MT₁ and the base station BS is taken down whereupon the first portable part MT₁ and the base station BS return into the IDLE state.

The sequence chart shown in FIG. 2 also specifies the states of a base station BS and its associated portable parts MT₁ . . . MTₙ, the states of the portable parts MT₂ to MTₙ₋₁ not being drawn for the purpose of simplification but corresponding to the sequence of the states of the portable part MTₙ.

In the initial state, all three entities shown are in the IDLE state. Following an incoming call request from an external remote subscriber which is signaled to the base station BS by a telecommunication network TKN, to which the base station is connected, the base station BS changes into the CALL state.

In the method explained in FIG. 2, in contrast to the method explained in FIG. 1, the base station BS is utilizes a unidirectional radio link normally existing to the respective associated portable parts MT₁ . . . MTₙ in a DECT system, this in each case being, for example, a dummy bearer or traffic bearer in the system operating in accordance with the DECT standard, via which the incoming call request is simultaneously signaled to all portable parts MT₁ . . . MTₙ, whereupon each one of the portable parts MT₁ . . . MTₙ changes into the CALL state and signals the incoming call request to the respective user, for example by a ringing signal.

After the signaling via the respective unidirectional radio link has ended, the base station BS successively sets up a bidirectional radio link with in each case one of the portable parts MT₁ . . . MTₙ allocated to the base station BS, the setting up of the radio link proceeding in familiar manner, for example in accordance with the DECT standard. The respective portable part MT₁ . . . MTₙ exchanges data, call patterns, display messages, voice adjustments etc (communication) with the base station BS via this radio link, the base station BS checking, by evaluating the data, whether the preceding signaling of the incoming call request via the unidirectional radio link has been received by the respective portable part MT₁ . . . MTₙ or not. Following this, the bidirectional radio link is released again and the same steps are repeated with a next one of the portable parts MT₁ . . . MTₙ until all n portable parts MT₁ . . . Tₙ have changed into the CALL state and this has been checked.

After a time preset in the base station has elapsed, the signaling of the call request to the portable parts MT₁ . . . MTₙ is refreshed if the incoming call request has not been accepted by one of the portable parts MT₁ . . . MTₙ.

For this purpose, the base station BS utilizes the existing unidirectional radio link (dummy bearer, traffic bearer) to all portable parts MT₁ . . . MTₙ, in which the continued existence of the incoming call is signaled via the respective unidirectional radio link so that the portable parts MT₁ . . . MTₙ continue the call signaling (ringing signal).

In addition, the signaling of the continued existence of the incoming call request can be checked by setting up a bidirectional radio link to in each case one portable part MT₁ . . . MTₙ, exchanging data and subsequently taking down the bidirectional radio link [lacuna] sequential continuation of this procedure.

As an alternative, however, the continuation of the refreshing of the can be signaled and, at the same time, checked only by setting up a bidirectional radio link to in each case one portable part MT₁ . . . MTₙ, exchanging data which contain the continued existence of the incoming call request and then taking down the bidirectional radio link [lacuna] sequentially continuing this procedure.

If the incoming call request is accepted by a subscriber, for example by operating a key, according to FIG. 2, at the portable part MT₁, the base station BS and the portable part MT₁ change into the TALK state and the base station signals the end of the incoming call request to the remaining portable parts MT₂ . . . MTₙ, using for this purpose a simultaneously in each case the existing unidirectional radio link (dummy bearer, traffic bearer) to the remaining portable parts MT₂ . . . MTₙ.

The remaining portable parts MT₁ . . . MTₙ then change into the IDLE state.

After the end of the call between the external subscriber and the first portable part MT₁, the bidirectional radio link is also taken down immediately so that both the first portable part MT₁ and the base station BS change into the IDLE state.

FIG. 3 shows how the method explained in FIG. 2 handles the occurrence of the end of an incoming call request before an acceptance of the incoming call request.

I.e., a first signaling of an incoming call request and checking takes place in accordance with the method explained in FIG. 2.

As an alternative, it can also take place in accordance with the method explained in FIG. 1.

After the checking, a refreshing, taking place in accordance with the method described in FIG. 2, of the signaling of the incoming call request is regularly carried out at identical time intervals in familiar manner—stimulated by the base station, so that the portable parts MT₁ . . . MTₙ can in each case continue the call signaling, and the respective portable part MT₁ . . . MTₙ starts with each incoming refreshing of the signaling a timer which, after a predetermined time has elapsed which is permanently implemented in the portable part or can be set as a parameter in which no further refreshing of the signaling takes place, ends the call signaling of the portable part MT₁ . . . MTₙ so that it changes into the IDLE state.

As an alternative, instead, an ending of the call signal can be actively achieved by means of signaling by the base station BS, this being done, for example, at the same time by utilizing the unidirectional radio link existing in each case to all portable parts MT₁ . . . MTₙ or, as an alternative, by setting up a bidirectional radio link and subsequently exchanging data and taking down the radio link to a portable part and sequentially continuing this process until the end of the call has been signaled to all portable parts MT₁ . . . MTₙ.

As an alternative, a signaling or message from one of the portable parts MT₁ . . . MTₙ which is in the CALL state can be directed to the base station BS, the portable part MT₁ . . . MTₙ setting up for this purpose a radio link for the base station BS, transmitting data containing the message to the base station BS and following this taking down the radio link.

This radio link can be directed unidirectionally from the portable station MT₁ . . . MTₙ to the base station BDS but, as an alternative, can also be bidirectional.

Independently of the variant of radio link, there is the possibility that no radio channel is free so that no radio link is established.

In such a case, the portable part MT₁ . . . MTₙ can basically discard the message, i.e. aborts the attempt of setting up a radio link.

As an alternative, the method explained in FIGS. 1 to 3 can be extended so that the portable part MT₁ . . . MTₙ aborts the attempt of setting up a radio link in dependence on the content, i.e. possible contents are prioritized in accordance with their content, or attempts the attempt to set up the radio link, for example, stimulated by a timer.

1. A method for call signaling in a telecommunication system with wireless telecommunication between a base station (BS) and a portable part (MT₁ . . . MTₙ), a number of “n” portable parts (MT₁ . . . MTₙ) being allocated to the base station (BS) and a number “k” of radio channels being available, comprising the following features:
a) in the case of an incoming call request signaled to the base station (BS) by a telecommunication network (TKN), the base station (BS) sets up a bidirectional radio link to a first portable part (MTₓ, with 1≦x≦n) of the n portable parts (MT₁ . . . MTₙ),
b) the base station (BS) exchanges data with the first portable part (MTₓ, with 1≦x≦n) via the bidirectional radio link,
c) the base station (BS) signals the incoming call request to the first portable part (MTₓ, with 1≦x≦n) by means of the data exchanged via the radio link,
d) the first portable part (MTₓ, with 1≦x≦n) indicates the signaled call request by means of appropriate call signaling,
e) the base station (BS) releases the bidirectional link to the first portable part (MTₓ, with 1≦x≦n), the call signaling being retained at the first portable part (MTₓ, with 1≦x≦n),
f) steps a) to e) are performed sequentially with a first group of portable parts which covers some of the portable parts (MT₁ . . . MTₙ).

2. The method for call signaling in a telecommunication system with wireless telecommunication between a base station (BS) and a portable part (MT₁ . . . MTₙ), a number of “n” portable parts (MT₁ . . . MTₙ) being allocated to the base station (BS) and a number “k” of radio channels being available, comprising the following features:
a) The base station maintains a unidirectional radio link to a first group of portable parts which covers some of the portable parts (MT₁ . . . MTₙ),
b) in the case of an incoming call request signaled to the base station (BS) by a telecommunication network (TKN), the base station (BS) simultaneously signals the incoming call request to the first group of portable parts via the unidirectional radio link,
c) the portable parts in the first group of portable parts indicate the signaled call request by corresponding call signaling,
d) the base station (BS) ends the signaling of the call request via the unidirectional radio link,
e) the base station (BS) sets up a bidirectional radio link with a first portable part (MTₓ, with 1≦x≦n) of the first group of portable parts,
f) the base station (BS) exchanges data with the first portable part (MTₓ, with 1≦x≦n) via the bidirectional radio link,
g) the base station (BS) releases the bidirectional link with the first portable part (MTₓ, with 1≦x≦n),
h) steps e) to g) is carried out sequentially with the first group of portable parts.

3. The method as claimed in one of claims 1 or 2, characterized [lacuna] the number “n” of the portable parts (MT₁ . . . MTₙ) allocated to the base station (BS) is smaller than the number “k” of radio channels, that is to say the designation “n>k” holds true.

4. The method as claimed in one of the preceding claims, characterized in that
a) the incoming call request is accepted by a second portable part (MT_{y}, with 1≦y≦n) of the first group of portable parts by means of a setting-up of a bidirectional radio link to the base station (BS), initialized by the second portable part (MT_{y}, with 1≦y≦n),
b) after completed setting up of the bidirectional radio link, the base station (BS) indicates the end of the incoming call request to the remaining portable parts of the first group of portable parts.

5. The method as claimed in claim 4, characterized in that the first portable part (MTₓ, with 1≦x≦n) is also the second portable part (MT_{y}, with 1≦y≦n).

6. The method as claimed in claim 4 or 5, characterized in that the end of the incoming call request is indicated in such a manner that
a) the base station (BS) sets up a bidirectional radio link with a third portable part (MT_{z}, with 1≦z≦n) of the remaining portable parts of the first group of portable parts,
b) the base station (BS) signals the end of the incoming call request to the third portable part (MT_{z}, with 1≦z≦n) with the data exchanged via the radio link,
c) the third portable part (MT_{z}, with 1≦z≦n) stops the call signaling,
d) the base station (BS) releases the bidirectional link to the third portable part (MT_{z}, with 1≦z≦n)),
e) steps a) to d) are carries out sequentially with a second group of portable parts which covers at least some [lacuna] remaining portable parts of the first group of portable parts.

7. The method as claimed in claim 4 or 5, characterized in that the end of the incoming call request is indicated in such a manner that
a) the base station maintains a unidirectional radio link to a third group of portable parts which covers at least some of the remaining portable parts of the first group of portable parts,
b) the base station (BS) simultaneously signals the end of the incoming call request via the unidirectional radio link to the third group of portable parts,
c) the portable parts of the third group of portable parts stop the call signaling,
d) the base station (BS) ends the signaling of the call request via the unidirectional radio link.

8. The method as claimed in one of claims 1 to 3, characterized in that the signaling of the incoming call request is refreshed in such a manner that
a) the base station (BS) sets up a bidirectional radio link to the first portable part (MTₓ, with 1≦x≦n),
b) the base station (BS) exchanges data with the first portable part (MTₓ, with 1≦x≦n) via the bidirectional radio link,
c) the base station (BS) signals the incoming call request to the first portable part (MTₓ, with 1≦x≦n) by means of the data exchanged via the radio link,
d) the first portable part (MTₓ, with 1≦x≦n) indicates the signaled call request to a subscriber by appropriate call signaling,
e) the base station (BS) releases the bidirectional link to the first portable part (MTₓ, with 1≦x≦n), the call signaling being retained at the first portable part (MTₓ, with 1≦x≦n),
f) steps a) to e) are performed sequentially with a first group of portable parts which covers some of the portable parts (MT₁ . . . MTₙ),
g) steps a) to f) are repeated cyclically.

9. The method as claimed in one of claims 1 to 3, characterized in that the signaling of the incoming call request is refreshed in such a manner that
a) the base station maintains a unidirectional radio link to a first group of portable parts which covers some of the portable parts (MT₁ . . . MTₙ),
b) the base station (BS) simultaneously signals the incoming call request to the first group of portable parts via the unidirectional radio link,
c) the portable parts of the first group of portable parts indicate the signaled call request by appropriate call signaling,
d) the base station (BS) ends the signaling of the call request via the unidirectional radio link,
e) steps a) to d) are repeated cyclically.

10. The method as claimed in one of claims 8 or 9, characterized in that the call signaling of the incoming call request by the respective portable part of the first group of portable parts takes place until the base station (BS) signals the end of the call request to the respective portable part of the first group of portable parts.

11. The method as claimed in claim 10, characterized in that the base station (BS) indicates the end of the incoming call request in such a manner that
a) the base station maintains a unidirectional radio link to a first group of portable parts which covers some of the portable parts (MT₁ . . . MTₙ),
b) the base station (BS) simultaneously signals the end of the call request to the first group of portable parts via the unidirectional radio link,
c) the base station (BS) ends the signaling of the end of the incoming call request via the unidirectional radio link.

12. The method as claimed in claim 10, characterized in that the base station (BS) indicates the end of the incoming call request in such a manner that
a) the base station (BS) sets up a bidirectional radio link to the first portable part (MTₓ, with 1≦x≦n),
b) the base station (BS) exchanges data with the first portable part (MTₓ, with 1≦x≦n) via the bidirectional radio link,
c) the base station (BS) signals the end of the incoming call request to the first portable part (MTₓ, with 1≦x≦n) by means of the data exchanged via the radio link,
d) the base station (BS) releases the bidirectional link to the first portable part (MTₓ, with 1≦x≦n),
e) steps a) to d) are sequentially performed with the first group of portable parts which covers some of the portable parts (MT₁ . . . MTₙ).

13. The method as claimed in one of claims 8 or 9, characterized in that the call signaling of the incoming call request by the respective portable part of the first group of portable parts takes place until a timer of the respective portable part of the first group of portable parts, which detects a time which has elapsed since the last signaling of the incoming call request, reaches a predetermined value of the time (TIMEOUT).

14. The method as claimed in one of the preceding claims, characterized in that changes of data allocated to the incoming call request are transmitted to the n portable parts (MT₁ . . . MTₙ) in such a manner that
a) the base station (BS) sets up a bidirectional radio link to the first portable part (MTₓ, with 1≦x≦n),
b) the base station (BS) transmits the changed data allocated to the call request to the first portable part (MTₓ, with 1≦x≦n) by means of the [lacuna] exchanged via the bidirectional radio link,
c) the base station (BS) releases the bidirectional link to the first portable part (MTₓ, with 1≦x≦n),
d) steps a) to c) are sequentially performed with the first group of portable parts which covers some of the portable parts (MT₁ . . . MTₙ).

15. The method as claimed in one of the preceding claims, characterized in that changes of data allocated to the incoming call request are transmitted to the n portable parts (MT₁ . . . MTₙ) in such a manner that
a) the base station maintains a unidirectional radio link to a first group of portable parts which covers some of the portable parts (MT₁ . . . MTₙ),
b) the base station (BS) simultaneously transmits the changed data allocated to the call request to the first group of portable parts via the unidirectional radio link,
c) the base station (BS) ends the transmission via the unidirectional radio link.

16. The method as claimed in one of the preceding claims, characterized in that for a transmission of a message directed to the base station (BS) from a portable part of the first group of portable parts takes place in such a manner that
a) the portable part of the first group of portable parts sets up a radio link to the base station (BS),
b) the portable part transmits the data directed to the base station to the first group of portable parts,
c) the portable part of the first group of portable parts takes down the radio link.

17. The method as claimed in claim 16, characterized in that, if all available radio channels are occupied,
a) the portable station of the first group of portable parts does not set up a radio link and discards the data directed to the base station (BS) if the data directed to the base station (BS) have low priority,
b) the portable station of the first group of portable parts, if the data directed to the base station (BS) have a high priority,
b1) starts a timer,
b2) attempts to set up a radio link again when a predetermined value of the time is reached,
b3) repeats steps b1) and b2) when all available radio channels are occupied.
